(19) United States
(12) Patent Application Publication
(10) Pub. No.: US 2016/0273562 A1
(43) Pub. Date: Sep. 22, 2016

(54) SYSTEM AND METHOD FOR MULTIPLE DIRECTION CONTROL OF FLOW

(71) Applicant: RAMOT AT TEL-AVIV UNIVERSITY LTD., Tel Aviv (IL)

(72) Inventors: Avraham SEIFERT, Tel-Aviv (IL); Danny DOLGOPYAT, RaAnana (IL)

(21) Appl. No.: 15/025,287

(22) PCT Filed: Oct. 2, 2014
(86) PCT No.: PCT/IL2014/050869

§ 371 Date: Mar. 28, 2016

Related U.S. Application Data
(60) Provisional application No. 61/886,155, filed on Oct. 3, 2013.

(51) Int. Cl. F15D 1/00; B64C 21/02; F15D 1/12

(52) U.S. Cl. CPC F15D 1/008; F15D 1/12; B64C 21/025; B64C 2230/06

(57) ABSTRACT

A fluidic system is disclosed. The fluidic system comprises a switching valve having a fluidic oscillatory actuator, a first blowing actuator and a second blowing actuator. The first blowing actuator is switchable by the switching valve and is configured for producing an output of fluid flow engaging a first plane. The second blowing actuator is also switchable by the switching valve and is configured for producing an output of fluid flow engaging a second plane. The second plane is different from the first plane.

### RELATED APPLICATION

This application claims the benefit of priority of U.S. Provisional Patent Application No. 61/886,155 filed Oct. 3, 2013, the contents of which are incorporated herein by reference in their entirety.

### FIELD AND BACKGROUND OF THE INVENTION

The present invention, in some embodiments thereof, relates to flow control and, more particularly, but not exclusively, to a system and method for multiple direction control of flow.

Flow control technology relates generally to the capability to alter flow properties relative to their natural tendency by introduction of a constant, or periodic, excitation. Use of a periodic excitation for control of boundary layer separation has been demonstrated to be both possible and efficient in incompressible flows [Seifert, A., Darabi, A. and Wygnanski, I., 1996, “Delay of Airfoil Stall by Periodic Excitation”, J of Aircraft. Vol. 33, No. 4, pp. 691-699; Seifert, A. and Pack, L. G., “Oscillatory Control of Separation at High Reynolds Numbers”, AIAA J. Vol. 37, No. 9, September 1999, pp. 1062-1071].

Control of boundary layer separation in compressible flows has also been demonstrated [Seifert, A. and Pack, L. G., “Oscillatory Control of Shock-induced Separation”, (AIAA paper 99 0925), J. Aircraft, 2001, V38, N3, pp. 464-472; Seifert, A. and Pack, L. G., “Effects of Compressibility and Excitation Slot Location on Active Separation Control at High Reynolds Numbers”, J. Aircraft 40, (1):110-119, 2003].

One of the primary uses of flow control is boundary layer control to prevent unwanted boundary layer separation. Significant scientific and technological effort has been invested in control of boundary layer separation. Alternate methods of flow actuation have been examined including mechanical mixing (e.g., vortex generators, Allan et al, Numerical Simulations of Vortex Generator Vanes and Jets on a Flat Plate, AIAA Paper 2002 3160), pneumatic vortex generator jets (e.g., steady and oscillatory, Johnston, et al., 2002, International J. of Heat and Fluid Flow, 23(6):750; Khan and Johnston, 2000, International J. of Heat and Fluid Flow, 21(5):505), and cyclic excitation. In an external flow, it has been demonstrated that cyclic excitation is more efficient than steady excitation for boundary layer control by about two orders of magnitude (Seifert, et al., 1996, supra).

U.S. Pat. No. 7,055,541 discloses a suction and periodic excitation flow control mechanism. The mechanism includes: a jet of fluid at a controlled input pressure which is directed by control pressure gradient between two opposite ports at the sides of the jet. The mechanism also comprises an ejector and a suction slot(s) or hole(s) for allowing additional fluid to join the primary flow and create an amplified flow. An oscillating deflection device directs the amplified flow in two or more exit directions.

### SUMMARY OF THE INVENTION

According to an aspect of some embodiments of the present invention there is provided a fluidic system. The system comprises a switching valve having a fluidic oscillatory actuator, a first blowing actuator being switchable by the switching valve and configured for producing an output of fluid flow engaging a first plane, and a second blowing actuator, also being switchable by the switching valve and configured for producing an output of fluid flow engaging a second plane, different from the first plane.

According to some embodiments of the invention at least one the first blowing actuator and the second blowing actuator is a pulsed blowing actuator.

According to some embodiments of the invention at least one the first blowing actuator and the second blowing actuator is a sideways oscillation pulsed blowing actuator.

According to some embodiments of the invention the system comprises at least one additional blowing actuator, also being switchable by the switching valve and configured for producing an output of fluid flow engaging at least one additional plane, different from the first and the second planes.

According to some embodiments of the invention the first and the second planes intersect.

According to some embodiments of the invention the first and the second planes are perpendicular to each other.

According to some embodiments of the invention the first and the second blowing actuators are arranged generally parallel to an intersection line between the first and the second planes.

According to some embodiments of the invention the first and the second blowing actuators are arranged at an angle to an intersection line between the first and the second planes.

According to some embodiments of the invention the first and the second blowing actuators are arranged generally perpendicular to an intersection line between the first and the second planes.

According to some embodiments of the invention the system is mounted on an aerodynamic or hydrodynamic, internal or external, wall surface, wherein the first blowing actuator is arranged to separate a boundary layer of fluid flow from the wall surface.

According to some embodiments of the invention at least one of the blowing actuators is arranged to provide pulsed blowing oscillation of fluid flow, generally normal to the surface.

According to some embodiments of the invention at least one of the blowing actuators is arranged to provide pulsed blowing oscillation of fluid flow, generally tangentially to the surface.

According to some embodiments of the invention the system is mounted on an aerodynamic or hydrodynamic, internal or external, wall surface of an object, wherein the first blowing actuator is arranged to separate a boundary layer of fluid flow from the wall surface, and the second blowing actuator is arranged to reattach the boundary layer to the wall surface.

According to some embodiments of the invention the first blowing actuator is mounted on a first aerodynamic or hydrodynamic wall surface of an object and is arranged to provide pulsed blowing oscillation of fluid flow, generally tangentially to the first surface, and the second blowing actuator is mounted on a second aerodynamic or hydrodynamic wall surface of the object and is arranged to provide pulsed blowing oscillation of fluid flow, generally perpendicular to the second surface.

According to some embodiments of the invention the first surface and second surfaces are on opposite sides of the object.

According to some embodiments of the invention the first surface is an upper surface of the object, and the second surface is a lower surface of the object.

According to some embodiments of the invention the second surface is an upper surface of the object, and the first surface is a lower surface of the object.

According to some embodiments of the invention the object is an aerial vehicle.

According to some embodiments of the invention the object is a ground vehicle.

According to some embodiments of the invention the object is an aqueous vehicle.

According to some embodiments of the invention the object is a subaqueous vehicle.

According to some embodiments of the invention the object is an amphibious vehicle.

According to some embodiments of the invention the object is a semi-amphibious vehicle.

According to some embodiments of the invention the object is an aircraft wing.

According to some embodiments of the invention the object is a control or aero surface of a vehicle.

According to some embodiments of the invention the object is an internal passageway.

According to some embodiments of the invention the system comprises a controller configured for activating the switching valve to provide a predetermined lift coefficient.

According to some embodiments of the invention the system comprises a controller configured for activating the switching valve to provide a predetermined drag coefficient.

According to some embodiments of the invention the system comprises a controller configured for activating the switching valve to simultaneously control a drag coefficient and a lift coefficient.

According to some embodiments of the invention the system comprises a controller configured for activating the switching valve to provide a generally constant lift coefficient and a varying drag coefficient.

According to some embodiments of the invention the system comprises a controller configured for activating the switching valve to provide a generally constant drag coefficient and a varying lift coefficient.

According to some embodiments of the invention system comprises a controller configured for activating the switching valve to provide alternating blowing between a lower and an upper surface of the object.

According to an aspect of some embodiments of the present invention there is provided a method of controlling flow, comprises: operating a switching valve having a fluidic oscillatory actuator to switch a first blowing actuator to produce an output of fluid flow engaging a first plane, and a second blowing actuator to produce an output of fluid flow engaging a second plane, different from the first plane.

According to some embodiments of the invention the method comprises operating the switching valve to switch at least one additional blowing actuator to producing an output of fluid flow engaging at least one additional plane, different from the first and the second planes.

According to some embodiments of the invention the first blowing actuator is an SOaB actuator and the method comprises operating the SOaB actuator to form steady suction for wall attachment.

According to some embodiments of the invention the steady suction is simultaneous with tangential blowing flow.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-C are schematic illustrations of a fluidic system, according to various exemplary embodiments of the present invention;

FIGS. 2A and 2B are schematic illustrations of an exemplary system in which the blowing actuators are arranged on a wing generally parallel to an intersection line between two planes;

FIGS. 3A-D are schematic illustrations of an exemplary system in which the blowing actuators are arranged on a wing at an angle to the intersection line between the two planes that are displaced in a streamwise direction;

FIGS. 4A-B show velocity iso-contours (FIG. 4A) and velocity vectors (FIG. 4B), as obtained from simulation performed according to some embodiments of the present invention for an uncontrolled flow.

FIGS. 5A-C show velocity vectors (FIG. 5A), and velocity vectors enlarge at the jet proximity (FIG. 5B), and velocity iso-contours (FIG. 5C), as obtained from simulation performed according to some embodiments of the present invention for a system in which a first blowing actuator is operative;

FIGS. 6A-C show velocity vectors (FIG. 6A), and velocity vectors enlarge at the jet proximity (FIG. 6B), and velocity iso-contours (FIG. 6C), as obtained from simulation performed according to some embodiments of the present invention for a system in which only a second blowing actuator is operative;

FIGS. 7A-C show velocity vectors (FIG. 7A), and velocity vectors enlarge at the jet proximity (FIG. 7B), and velocity iso-contours (FIG. 7C), as obtained from simulation performed according to some embodiments of the present invention for a system in which two blowing actuators are operative; and

FIGS. 8A-F are schematic illustrations of an oscillatory blowing actuator, suitable to be used in a system according to some embodiments of the present invention.

### DESCRIPTION OF SPECIFIC EMBODIMENTS OF THE INVENTION

The present invention, in some embodiments thereof, relates to flow control and, more particularly, but not exclusively, to a system and method for multiple direction control of flow.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Some embodiments of the present invention provide a system which combines two or more fluidic actuators for controlling fluid flow. The fluidic actuators can be, for example, suction and oscillatory blowing (SaOB) fluidic actuators as described in U.S. Pat. No. 7,055,541, the contents of which are hereby incorporated by reference.

One of the actuators optionally and preferably serves as a switch for switching the other actuator(s). The other actuator(s) optionally and preferably serve as blowing actuator(s), e.g., pulsed or oscillatory blowing actuator(s). In some embodiments of the present invention the blowing actuators are arranged to create two independent surfaces (typically planar surfaces) of oscillatory blowing, in addition to selective suction locations.

Several such systems can be mounted on an object to form an array of fluidic systems. In some embodiments of the present invention synchronization is applied, for example, as disclosed in International Publication No. WO2013/061276, the contents of which are hereby incorporated by reference.

The system or array of the present embodiments can be used as a tool of aerodynamic performance control, e.g., an alternation of the airfoil lift drag and side forces and moments. By controlling the output of the actuators in both plains, the lift, moment and drag are controlled, optionally and preferably independently. Other planes of control can also be performed.

In various exemplary embodiments of the invention the blowing direction of each surface is adjusted to improve (e.g., optimize) the performances of the system array. This adjustment can reduce the number of systems used in the array and therefore increases the total energetic efficiency of the system and reduce its complexity.

Generally, high momentum wall-normal blowing tends to separate the flow while intermediate wall-tangential jet tends to reattach the flow. The system of the present embodiments affects the aerodynamic performance by manipulating the boundary layer (BL), alternating its resistance to separation. For example, actuation normal to the airfoil surface separates the BL therefore increases the drag. Lift decreases if separation is promoted without reattachment. When separation is provoked but reattachment occurs, lift generally increases. Conversely, tangential blowing reattaches the BL therefore contributes to the lift. Drag decreases when there is more attached flow than in the absence of flow control.

The system or array of the present embodiments can be used as roll, pitch and/or yaw controller when placed on the wings of a vehicle. The system or array of the present embodiments can be used as pitch controller when placed on the tail of a vehicle or on a region sufficiently far from the aerodynamic center of the vehicle. The system or array of the present embodiments is optionally and preferably used to control the motion direction of a vehicle without using any moving parts or control surfaces.

The system and method of the present embodiments can employ more than two (e.g., three or more) blowing actuators and or flow control systems. Each of the blowing actuators can be a steady blowing actuator or an unsteady blowing actuator. The two surfaces of flow can be directed according to some embodiments of the present invention along any direction to provide a multipurpose fluidic system. The system, method and array of the present embodiments can be used to combining the steady suction of the SaOB actuator to reattach the flow, instead of the downstream reattaching slot, or to enhance it. The system, method and array of the present embodiments can separate a BL with unsteady, pulsed, sideways oscillating jet. The localized nature of the actuation according to some embodiments of the present invention allows for three-dimensional jet distribution.

In some embodiments of the present invention a wall normal pulsed blowing oscillating jet is employed sideways on the lower surface of the object. In some embodiments of the present invention the system and method alternate blowing between lower and upper surface, using wall normal flow control. In some embodiments of the present invention the system and method provide wall tangential fluid control on lower surface to decrease lift and drag. In some embodiments of the present invention the system and method alternate between lower and upper surface fluid control using wall-tangential or wall-normal fluid control.

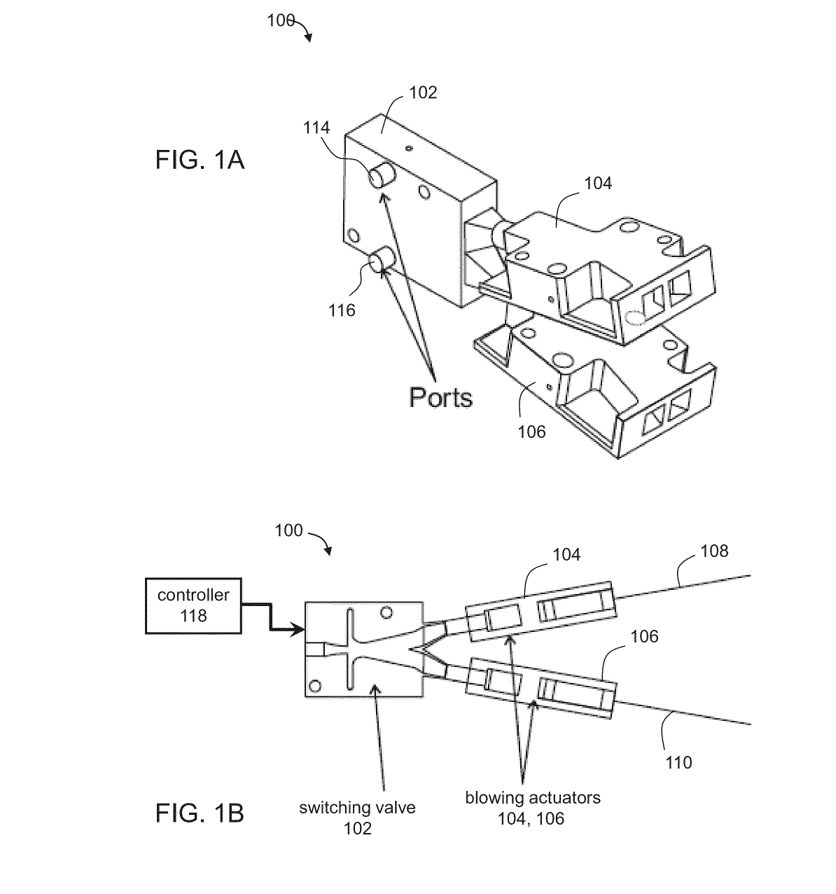

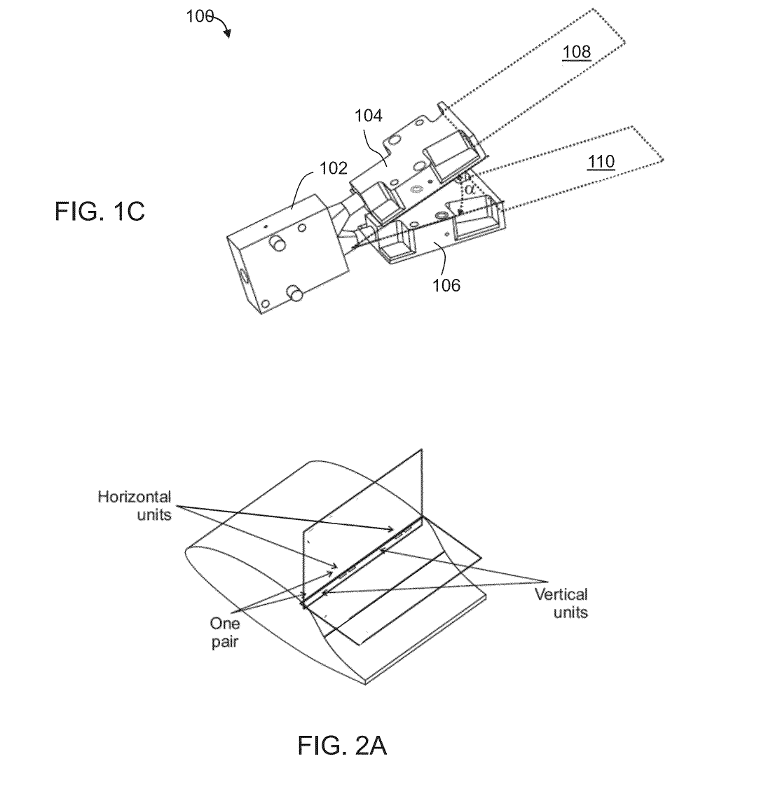

Reference is now made to FIGS. 1A-C which are schematic illustrations of a fluidic system 100, according to various exemplary embodiments of the present invention. System 100 comprises a switching valve 102, a first blowing actuator 104 and a second blowing actuator 106. FIGS. 1A-C show a direct connection between switching valve 102 and each of blowing actuators 104 and 106. However, this need not necessarily be the case, since, for some applications, it may not be necessary for the switching valve to be connected directly to the blowing actuators. The present embodiments also contemplate configurations in which the switching valve is connected to one or more of the blowing actuators by tubes (e.g., flexible or bent tubes) or by any other conduit, such as, but not limited to, printed or machined conduits, so as to allow the actuators to point in any desired direction, angel and orientation.

In some embodiments of the present invention switching valve 102 comprises a fluidic oscillatory actuator. In these embodiments switching valve 102 is optionally and preferably a SaOB actuator fluidic actuator as described, for example, in U.S. Pat. No. 7,055,541, the contents of which are hereby incorporated by reference. Aside from switching valve 102, one or more of the blowing actuators (e.g., all the blowing actuators) can also be a pulsed blowing actuators, such as, but not limited to, an SaOB actuator fluidic actuator, as described, for example, in U.S. Pat. No. 7,055,541, the contents of which are hereby incorporated by reference.

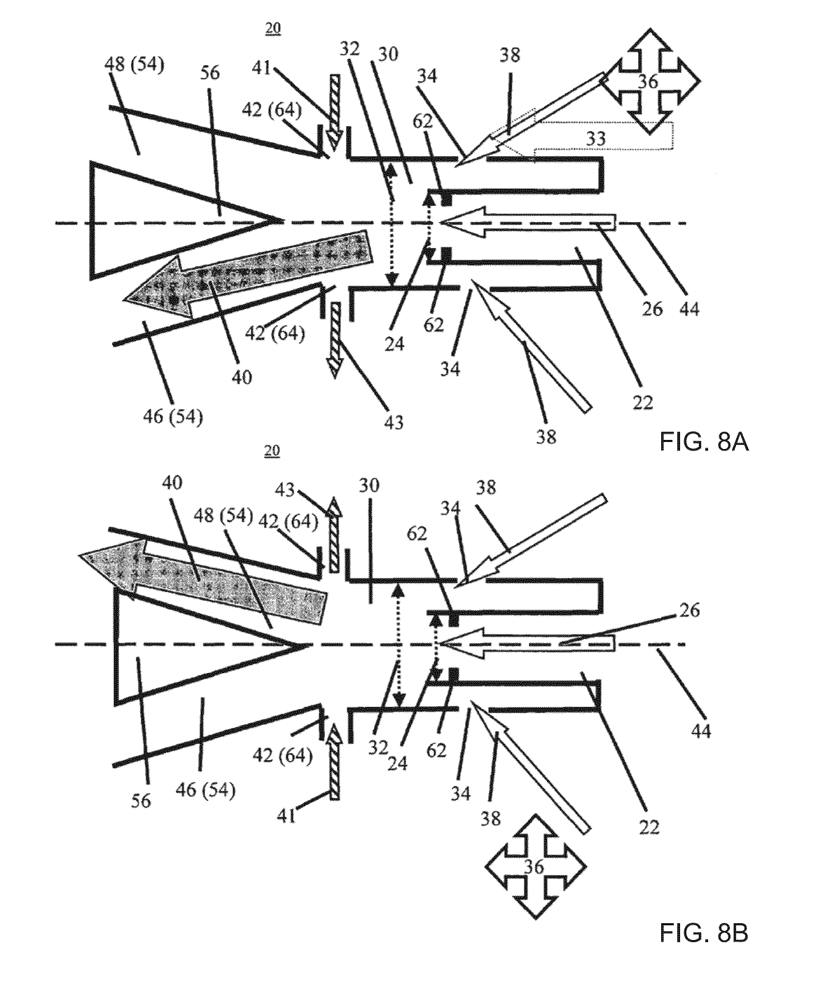

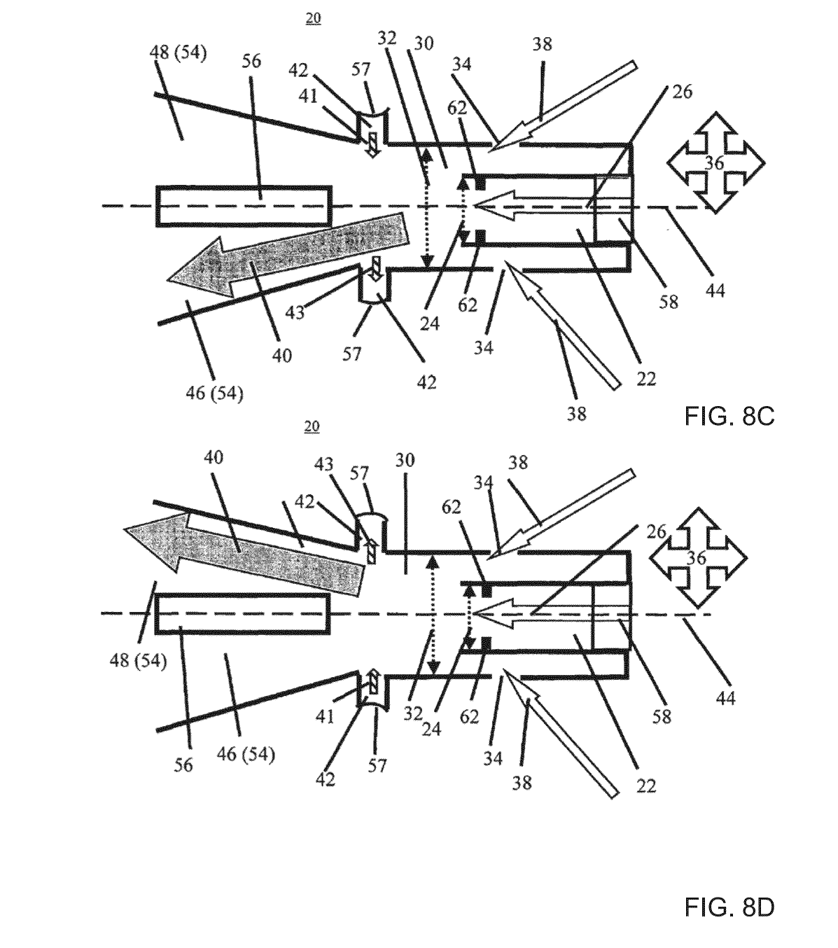

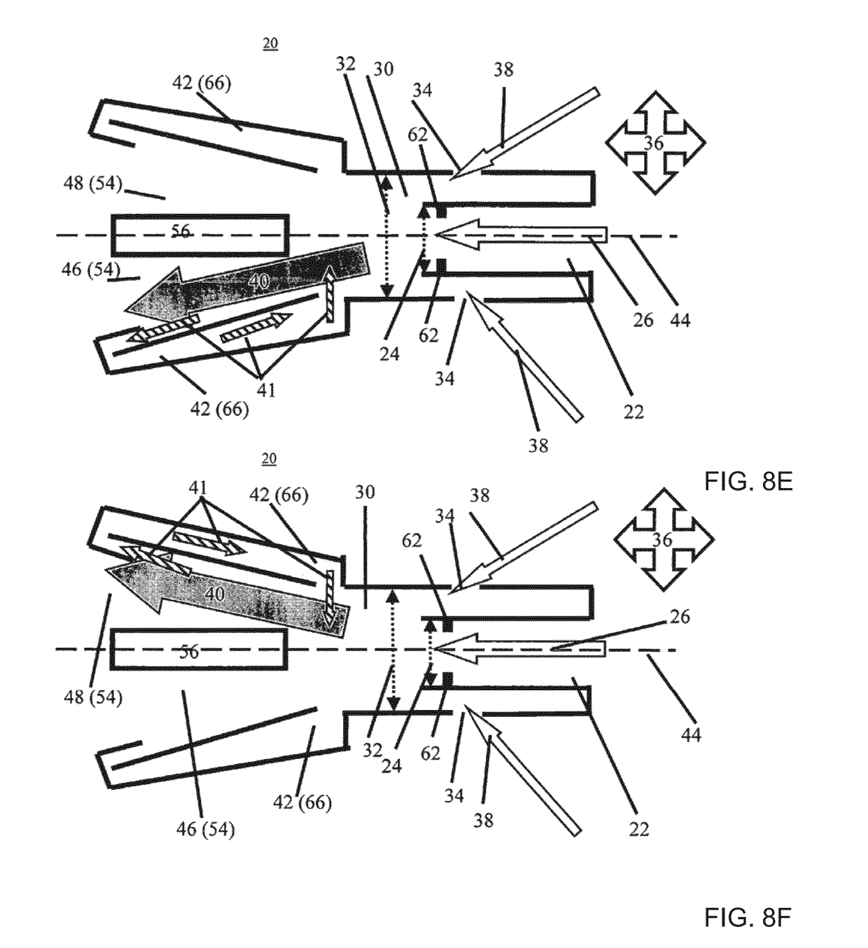

A representative example of an SaOB actuator 20 suitable for the present embodiments will now be described with reference to FIGS. 8A-F.

SaOB actuator 20 comprises an ejector member 22 characterized by a first diameter 24 (d1). The ejector member 22 is capable of directing a jet 26 (wide white arrow) of fluid at a controlled input pressure. The fluid may be, for example, air (gas) or water (liquid) or two or three phase flow of gas, liquid and solid particles. SaOB actuator 20 further comprises a joining channel 30 characterized by a second diameter 32 (d2). In various exemplary embodiments of the invention d2 is greater than d1. The joining channel 30 is in fluid communication and is capable of receiving flow 26 from the ejector member 22.

SaOB actuator 20 comprises one or more suction slots 34 in fluid communication with the joining channel 30 and an environment 36 external to the SaOB actuator. Suction slot(s) 34 are configured for allowing additional fluid 38 to join the jet 26 to create an amplified flow 40.

The term “slot” as used in suction slot 34 is to be construed in its widest possible sense for purposes of this specification and the accompanying claims. Slot, as used herein, refers to any open, or openable, channel of fluid communication. Thus, suction slots may be either permanent openings or openable apertures of any cross sectional shape.

SaOB actuator 20 can further comprise a deflection device or a set of control ports 42 configured for applying a transverse pressure differential (41 and/or 43; cross hatched arrows) to a longitudinal axis 44 of the jet 26 to direct amplified flow 40 in a first desired exit direction 46 (FIGS. 8A, 8C and 8E). Deflection device or set of control ports 42 is also configured for redirecting the amplified flow in at least one additional desired exit direction 48 (FIGS. 8B, 8D and 8F) by modifying a circumferential angle by which pressure differential (41 and/or 43) is transverse to longitudinal axis 44.

In FIGS. 8A-F, a total of two exit directions 46 and 48 are illustrated because the circumferential angle by which pressure differential (41 and/or 43) is transverse to longitudinal axis 44 has been modified by 180 degrees. It will be appreciated that any total number of exit directions 46 and 48 may be achieved by modifying the circumferential angle by which pressure differential (41 and/or 43) is transverse to longitudinal axis 44 by a circumferential angle defined by 360 degrees/n where n is the total number of exit directions 46 and 48 desired. Thus, if n=3, the circumferential angle is 120 degrees, two additional exit directions 48 are defined and a total of three exit directions 46 and 48 are employed. If n=4, the circumferential angle is 90 degrees, three additional exit directions 48 are defined and a total of four exit directions 46 and 48 are employed and so on and forth.

In the pictured embodiments first desired exit direction 46 and additional exit direction 48 are each defined by an exit port 54. Again, while two exit ports 54 are pictured, the scope of the invention includes mechanisms with as many as n exit ports where n is the total number of exit directions 46 and 48 desired as described hereinabove. Exit ports 54 may be defined, for example, by introduction of splitter 56 into conduit 30. Splitter 56 is optionally and preferably triangular (FIGS. 8A and 8B).

It will be appreciated that the total transverse pressure differential is the vector sum of positive differential 41 directed towards axis 44 and negative differential 43 directed away from axis 44. Thus, various embodiments of the invention may employ deflection devices or control ports 42 that apply only positive differential(s) 41, that apply only negative differential(s) 43 or that apply both positive differential(s) 41 and negative differential(s) 43.

Similarly, some preferred embodiments of the invention rely upon alternately applying only positive differential 41 and applying only negative differential 43 on the same side of axis 44.

Deflection device 42 may, for example, include at least one control port having a fluidic valve 64 (FIGS. 8A and 8B) capable of supplying at least a portion of (e.g., 41 and/or 43) pressure differential transverse to longitudinal axis 44 of flow 26 with a predetermined periodicity. According to this embodiment transverse pressure differential 41 and 43 is initially employed to direct amplified flow 40 in first exit direction 46. In response to a command from a controller (not shown, see FIG. 1B), the circumferential angle of transverse pressure differential 41 and 43 is rotated by 180 degrees and amplified flow 40 is directed to additional exit direction 48 (FIG. 8B). This process can be iteratively repeated in response to commands from the controller. The end result is that amplified flow 40 oscillates between exit directions 46 and 48 at a frequency determined by the controller.

Oscillation of flow 40 can also be achieved without the use of a controller. For example, it was found by the present inventors that oscillations can be generated by establishing a feedback loop between the control ports 42. In these embodiments, the oscillation is optionally and preferably generated without any moving part or energy expenditure. Such oscillation is referred to herein as self-oscillation.

In some embodiments of the present invention deflection device 42 comprise at least two opposing zero-mass-flux devices (FIGS. 8C and 8D) operating at a predetermined periodicity. Each of the zero mass flux devices 58 is capable of supplying at least a portion (41 and/or 43) of the pressure differential transverse to longitudinal axis 44 of the jet 26. Oscillation between exit directions 46 and 48 is achieved by causing zero mass flux devices 58 to operate out of phase so that at a first time point (FIG. 8C) one diaphragm 57 flexes into zero-mass-flux device 58 to create a positive pressure differential 41 while the diaphragm 57 of the second flexes out of zero-mass-flux device 58 to create a negative pressure differential 43. Amplified flow 40 is thus directed towards first exit direction 46 defined by exit port 54. At a subsequent time point, one half period of the oscillation frequency of zero mass flux devices 58, the situation is reversed (FIG. 8D) and amplified flow 40 is directed towards second exit direction 48 defined by exit port 54. According to additional embodiments of the invention, more than two zero mass flux devices 58 are employed to define more than two exit directions 46 and 48. Regardless of the total number of zero mass flux devices 58 employed, the total transverse pressure differential is the vector sum of all partial pressure differentials 41 and 43.

Alternately, or additionally, deflection device 42 may, for example, include at least two resonance tubes 66 (FIGS. 8E and 8F). Each of resonance tubes 66 is independently capable of capturing a portion 41 of amplified flow 40 as it flows in one of desired exit directions 46 or 48 and applying captured portion 41 of amplified flow transverse 41 to longitudinal axis 44 of flow 26 to create pressure differential 41. This causes amplified flow 40 to alter its exit direction.

Preferably, suction slot(s) 34 is deployed on a surface in contact with a boundary layer of an external fluid flow 33 (FIG. 8A) so that the additional fluid 38 joins the jet 26 via at least one suction opening 34 includes at least a portion of external fluid flow 33. External, as used with respect to flow 33, indicates external to the SaOB actuator 20.

Optionally, but preferably, at least a portion of flow 26 emanating from the ejector member 22 is supplied by at least one oscillatory zero-mass-flux jet 58 (FIGS. 8C and 8D). U.S. Pat. No. 6,751,530, the contents of which are hereby incorporated by reference, provides details of the principles of operation of oscillatory zero-mass-flux jets.

Optionally and preferably, flow 26 is mixed in proximity to a junction between the ejector member 22 and the joining channel 30. Mixing may be accomplished by means of a mixer, which may rely, at least in part, upon at least one protrusion 62 from an inner surface of ejector member 22. Protrusion(s) 62 create a disturbance in the jet 26 as flow 26 passes thereupon and mixing results. Alternately, or additionally, the mixer may include an active oscillatable (mechanical or fluidic) device, capable of introducing sufficient unsteadiness to the flow such that mixing is enhanced.

Referring now again to system 100, while FIGS. 1A-C show two blowing actuators 104 and 106, this need not necessarily be the case, since, for some applications, it may be desired to have more than two blowing actuators in system 100. One of ordinary skills in the art, provided with the details described herein would know how to construct a system with more than two blowing actuators.

Each of the blowing actuators is switchable by switching valve 102 and is configured for producing, responsively to the switching operation executed by valve 102, an output of fluid flow engaging a plane. Thus the present embodiments contemplate a configuration in which one SaOB actuator fluidic actuator execute a switching operation to one or more other SaOB actuator fluidic actuator. In some embodiments of the present invention system 100 comprises a controller 118 configured for activating switching valve 102. Controller 118 can be mechanical, electronic, pneumatic or a combination thereof. Preferably, the controller includes a computerized data processing device and suitable hardware interfaces operable by the controller with at least a certain level of autonomy once the commands are determined. Alternately, or additionally, the controller may require manual input of commands.

Switching can be achieved by providing a pressure difference across the ports 114 and 116 of switching valve 102. The pressure difference can be accomplished by deflecting a part of the mean stream to the ports or by closing one of the ports, for example, mechanically or fluidically.

In the embodiment illustrated in FIGS. 1A-C, in which system 100 comprises two blowing actuators 104 and 106, first blowing actuator 104 produces an output of fluid flow engaging a first plane 108, and second blowing actuator 106 produces an output of fluid flow engaging a second plane 110.

The planes are preferably different from each other. For example, the planes can be at an angle α to each other (see FIG. 1C). The angle α can have any value in the range (0°≦α≦180°).

In some embodiments, the planes are perpendicular to each other. When two planes are at an angle to each other, they intersect at an intersection line. The blowing actuators can be arranged generally parallel to the intersection line between the planes, or at an angle to the intersection line between the planes. Several exemplified configurations, which are not to be considered as limiting, are described in more detail in the Examples section that follows.

System 100 can be mounted any construction which is influenced by flow. Specifically, system 100 can be mounted on an aerodynamic wall surface of an object, or hydrodynamic wall surface an object. The wall surface can be internal or external with respect to the object. Many types of objects are contemplated. Representative examples including, without limitation, an aerial vehicle, a ground vehicle, an aqueous vehicle, a subaqueous vehicle, an amphibious vehicle, a semi-amphibious vehicle, and an aircraft wing.

The blowing actuators of system 100 can be arranged so as to manipulate the boundary layer of fluid flow along the wall surface. Such a manipulation can be accomplished, for example, by arranging one or more of the blowing actuators to provide fluid flow, optionally and preferably pulsed blowing oscillation of fluid flow, at a predetermined direction relative to the surface. Representative examples of directions including, without limitation, a direction that is generally normal to the surface, and a direction that is generally tangentially to the surface. In some embodiments of the present invention the blowing actuators are arranged to provide sideways pulsed blowing oscillation of fluid flow.

Herein, the term “sideways” describes a direction which is at an angle β to the direction of the motion of the vehicle and tangential to the surface, wherein β is more than 0° and less than 180°, preferably from about 20° to about 160°, or from about 40° to about 140°, or from about 60° to about 120°, or from about 80° to about 100°, e.g., about 90°.

Other directions are also contemplated.

In some embodiments of the present invention the manipulation of flow includes separating the boundary layer from the wall surface, in some embodiments of the present invention the manipulation includes reattaching the boundary layer to the wall surface, and in some embodiments of the present invention the manipulation includes separating the boundary layer from the wall surface and then reattaching it back to the wall surface. The latter embodiments can be accomplished by arranging one of the actuators to effect the separation and the other actuator to effect the reattachment.

Also contemplated, are embodiments in which two or more blowing actuators are mounted on respective two or more wall surfaces of the object. For example, one blowing actuator (e.g., actuator 104) can be is mounted on a first wall surface of the object and arranged to provide fluid flow, optionally and preferably pulsed blowing oscillation of fluid flow, generally tangentially to the first wall surface, and another blowing actuator (e.g., actuator 106) can be mounted on a second wall surface of the object and arranged to provide fluid flow, optionally and preferably pulsed blowing oscillation of fluid flow, generally perpendicular to the second surface. The first and second wall surfaces of the object can be, for example, the upper and lower wall surfaces of the object or vice versa.

The controller 118 of system, 100, in embodiments in which a controller is employed, can be configured in accordance with the desired functionality of system 100. For example, in some embodiments controller 118 is configured for activating switching valve 102 to provide a predetermined lift coefficient, in some embodiments controller 118 is configured for activating switching valve 102 to provide a predetermined drag coefficient, in some embodiments controller 118 is configured for activating switching valve 102 to simultaneously control a drag coefficient and a lift coefficient, in some embodiments controller 118 is configured for activating switching valve 102 to provide a generally constant lift coefficient and a varying drag coefficient, in some embodiments controller 118 is configured for activating switching valve 102 to provide a generally constant drag coefficient and a varying lift coefficient, and in some embodiments controller 118 is configured for activating switching valve 102 to provide alternating blowing between a lower and an upper surface of said object.

According to an aspect of some embodiments of the present invention there is provided a method suitable for controlling flow. The method comprises operating a switching valve, such as valve 102, to switch a first blowing actuator, e.g., actuator 104 to produce an output of fluid flow engaging a first plane, e.g., plane 108 and a second blowing actuator, e.g., actuator 106, to produce an output of fluid flow engaging a second plane, e.g., plane 110, as further detailed hereinabove.

In some embodiments of the present invention the method operates the switching valve also to switch one or more additional blowing actuator to producing an output of fluid flow engaging a respective one or more additional plane, as further detailed hereinabove.

In some embodiments of the present invention the method operates the SOaB actuator to form steady suction for wall attachment. The steady suction is optionally and preferably simultaneous with tangential blowing flow, which in some preferred embodiments can be a sideways oscillating blowing flow.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### Examples

Reference is now made to the following examples, which together with the above descriptions illustrate some embodiments of the invention in a non limiting fashion. It is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Exemplary Configurations

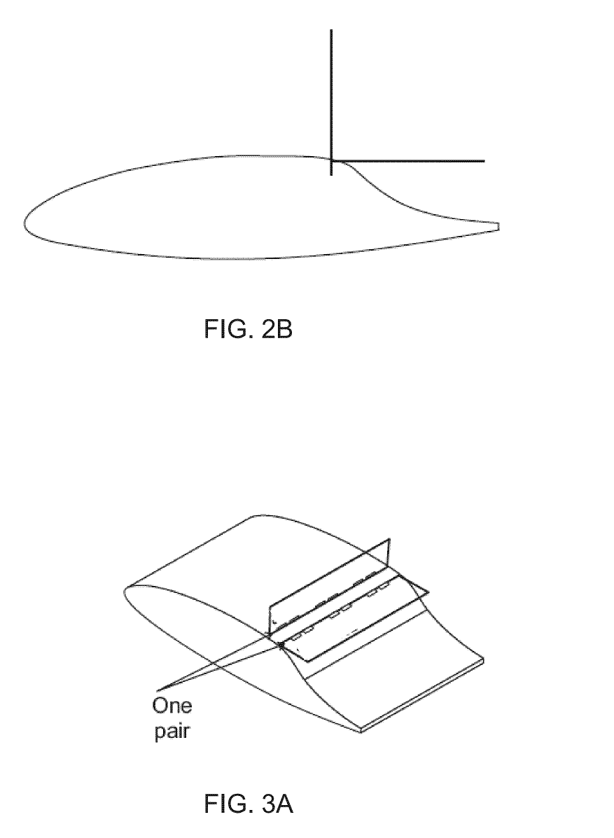

FIGS. 2A and 2B are schematic illustrations of an exemplary system array in which the blowing actuators are arranged on a wing generally parallel to an intersection line between the first and second planes. For example, a generally linear array of SaOB actuators can be arranged to creates two, generally perpendicular, different surfaces (e.g., vertical surface and horizontal surface), where each two nearby actuators point in different directions and one such couple is a bi-directional unit. In some embodiments of the present invention the chosen airfoil is a Glauert type airfoil. However, this need not necessarily be the case, since, for some applications, other types of airfoil geometry can be selected.

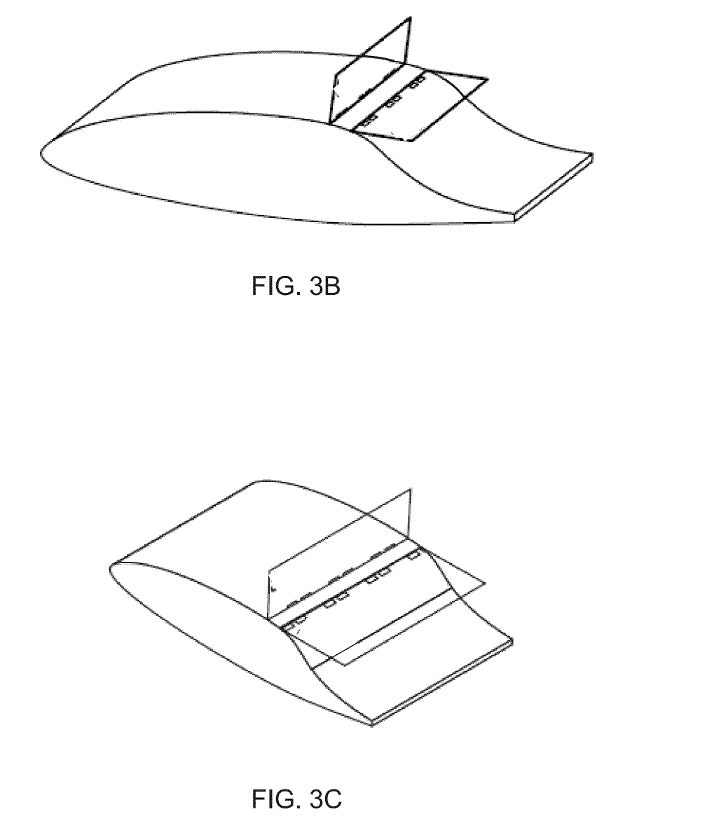

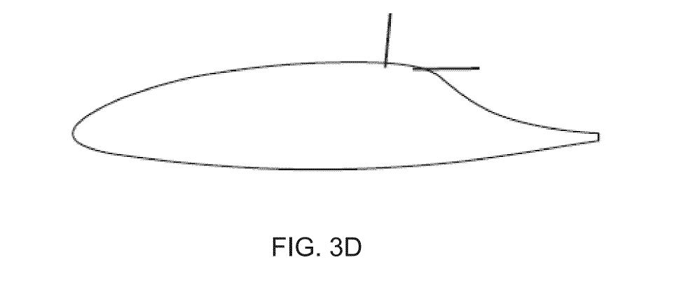

FIGS. 3A-D are schematic illustrations of an exemplary system array in which the blowing actuators are arranged on a wing at an angle to the intersection line between the first and second planes. For example, the two surfaces can be formed by actuators along different lines such that the surfaces are generally perpendicular one to another.

FIGS. 3A and 3B illustrate an embodiment in which the blowing actuators are arranged in a two-line configuration, FIG. 3C illustrates an embodiment in which the blowing actuators are arranged in a zigzag configuration, and FIG. 3D illustrates a side view of FIG. 3A. The angle between the surfaces in FIGS. 3A-D is about 90°, but can have other values, optionally and preferably, less than 170° or less than 135°.

In various exemplary embodiments of the invention a pair of oscillators are arranged one behind (downstream of) the other with respect to the flow direction. In these embodiments, the first surface (line of actuator slots) can separate the BL and the second surface (line of actuators) can reattach it back to the wing or eliminate its separation. Also contemplated is a Zigzag configuration as illustrated in FIG. 3C. This configuration can also form a closed recirculation bubble increasing both lift and drag.

### Computer Simulated Flow Fields

Computer simulations were performed according to some embodiments of the present invention simulated in ANSIS™ (FLUENT™) CFD code and it presents a 2D case of the embodiment in which the blowing actuators are arranged at an angle to the intersection line between the two planes.

The simulation presents a Glauert wing profile at chord Reynolds number of 500 k and considers turbulent effects (fully turbulent simulation).

The first (separation) surface was located at x/c=0.6 and the second (reattachment) surface was located at x/c=0.65, where c represent the chord. The chord was normalized to 1 meter (c=1 m). The jet velocity coming from the oscillators was 19 m/s. The free-stream velocity was 7.8 m/s and the airfoil incidence angle was 0°.

Four cases were considered: (a) Base line uncontrolled, (b) Only the first blowing actuator is operative, (c) only the second blowing actuator is operative, and (d) both blowing actuators are operative.

The lift (Cl) and drag (Cd) coefficients obtained by the simulation are summarized in Table 1, below.

TABLE 1

| | Cl | Cd | Separation point x/c |
|---|---|---|---|
| Case a | −0.114 | 0.0363 | 0.746 |
| Case b | −0.667 | 0.0793 | 0.538 |
| Case c | 0.215 | 0.0128 | 1 |
| Case d | 0.168 | 0.0243 | 0.609 |

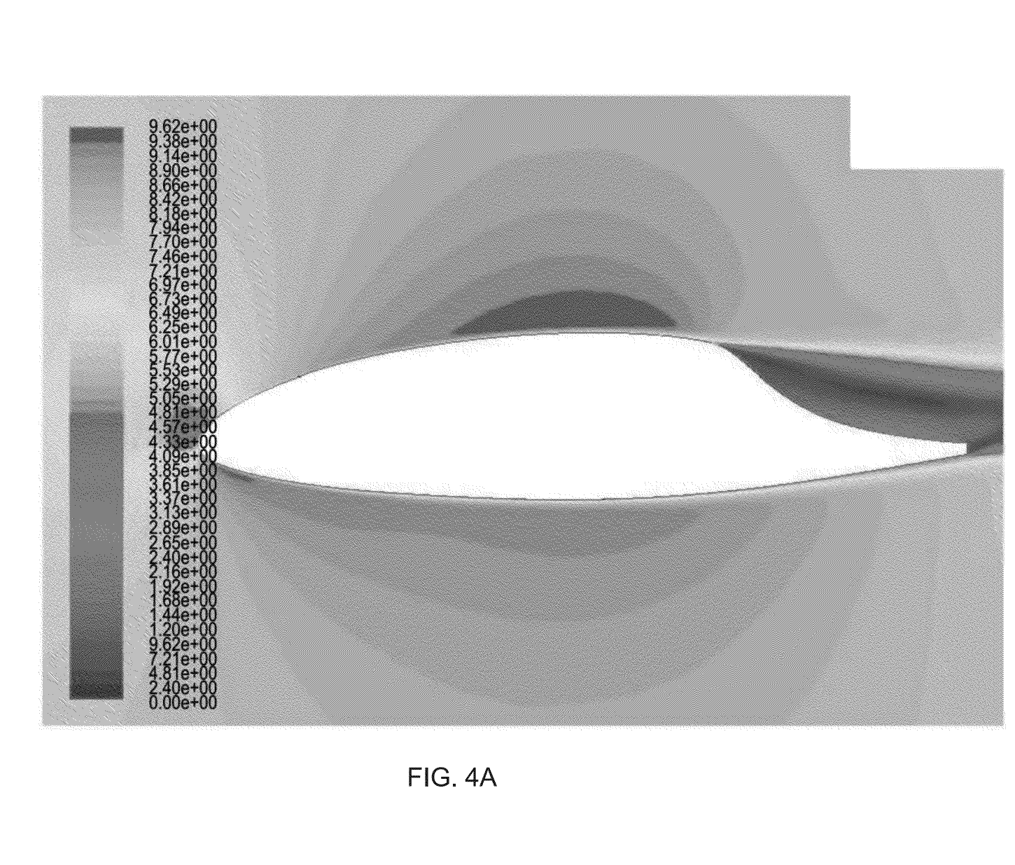

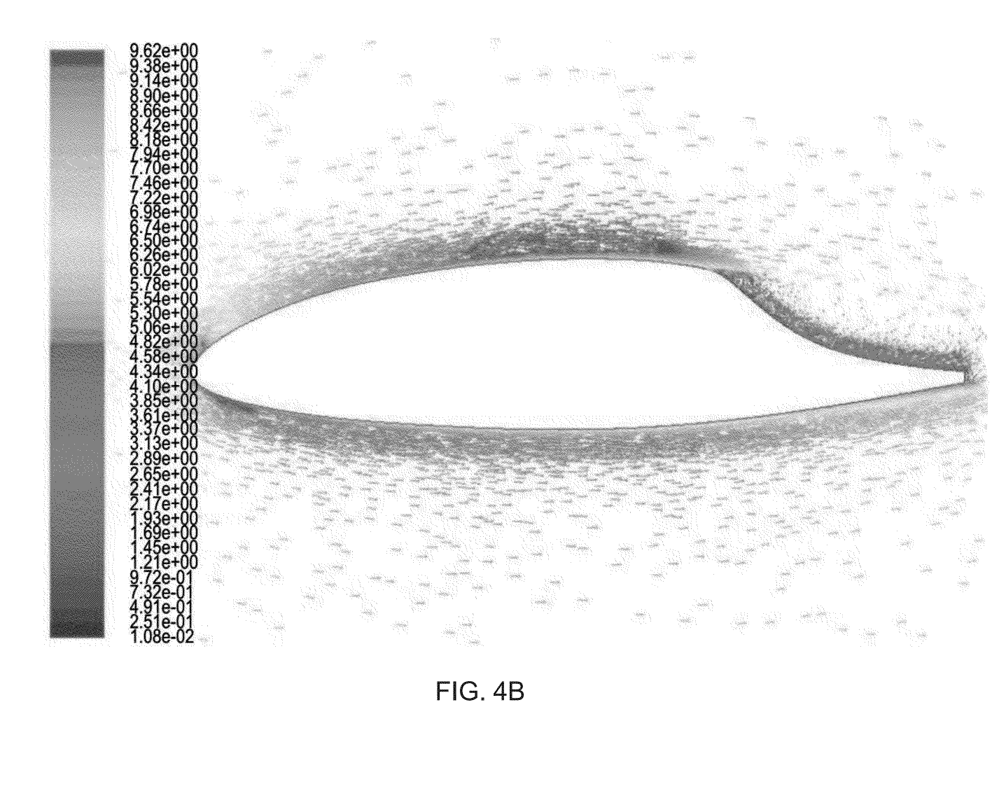

FIGS. 4A-B show simulation results for case (a), where FIG. 4A shows velocity iso-contours, and FIG. 4B shows velocity vectors.

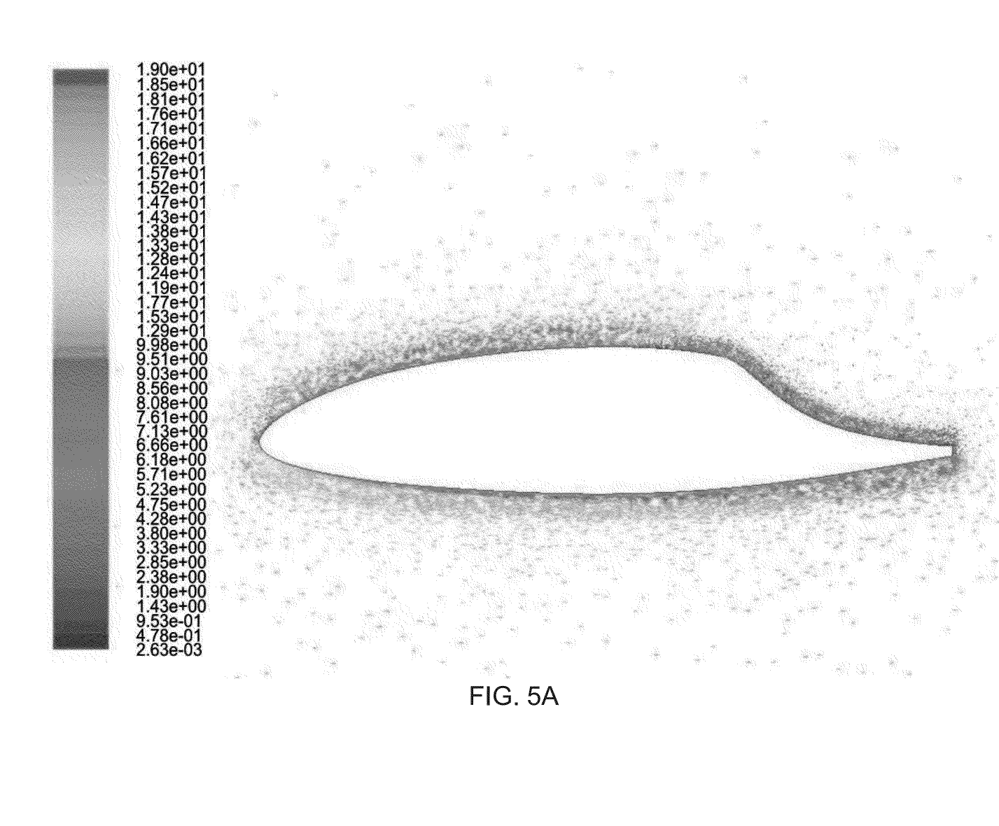

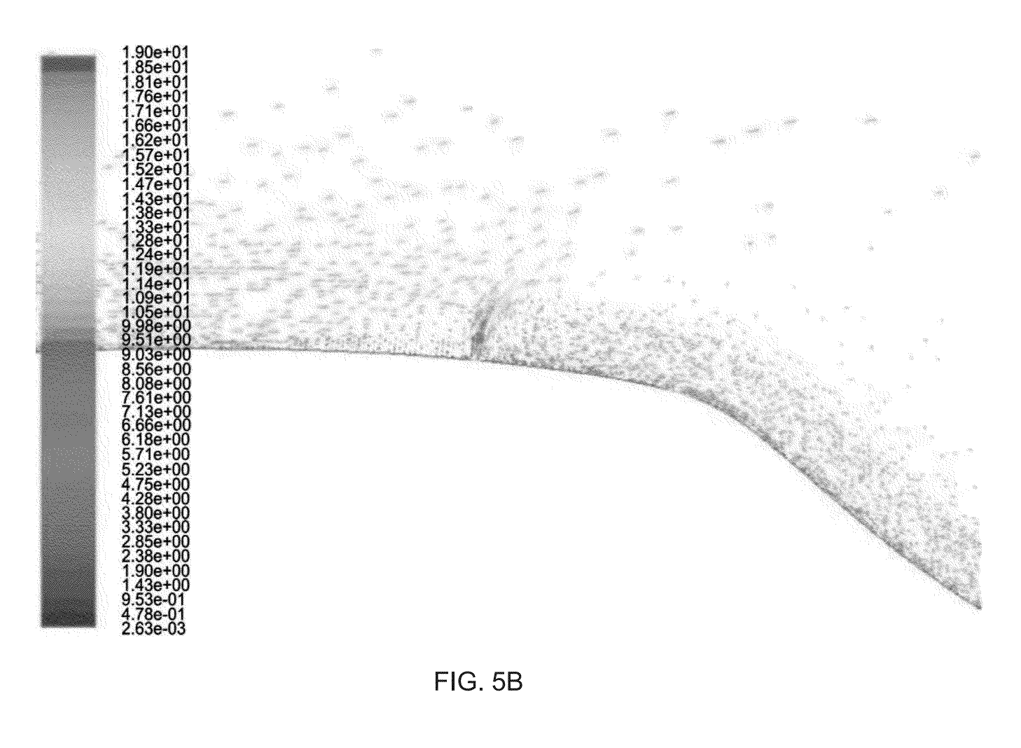

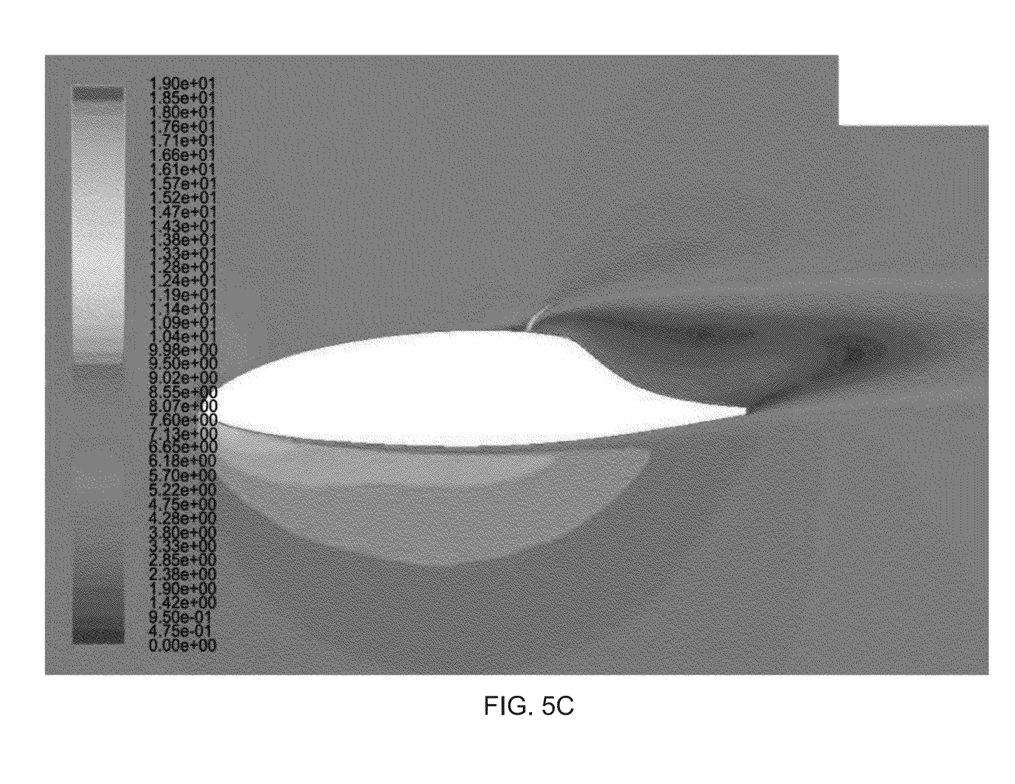

FIGS. 5A-C show simulation results for case (b), where FIG. 5A shows velocity vectors, FIG. 5B shows velocity vectors enlarge at the jet proximity, and FIG. 5C shows velocity iso-contours.

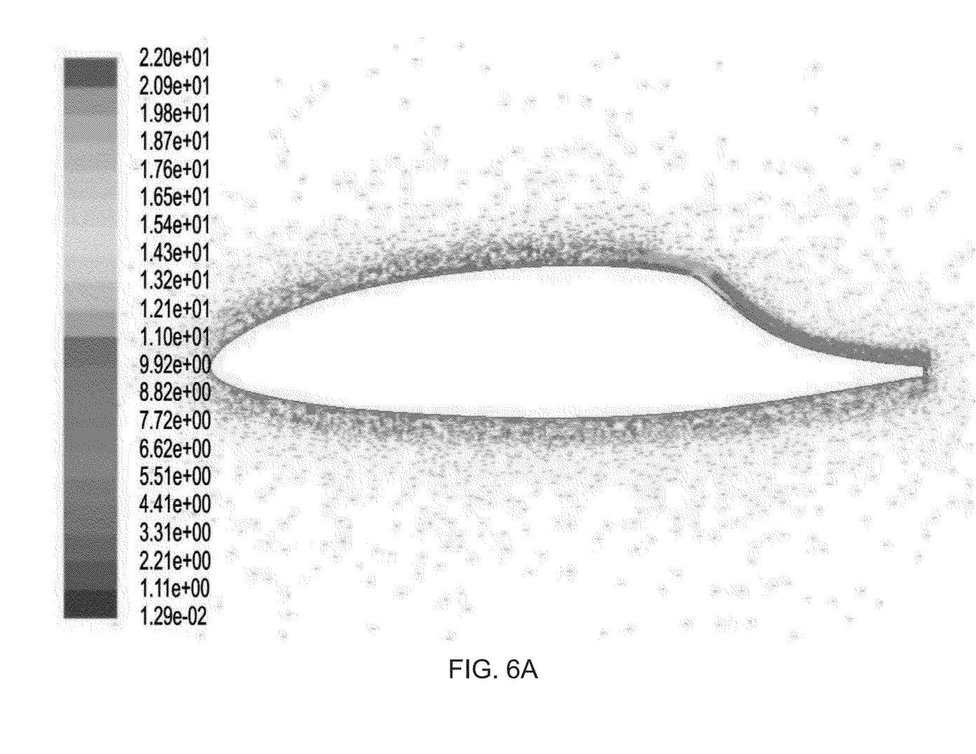

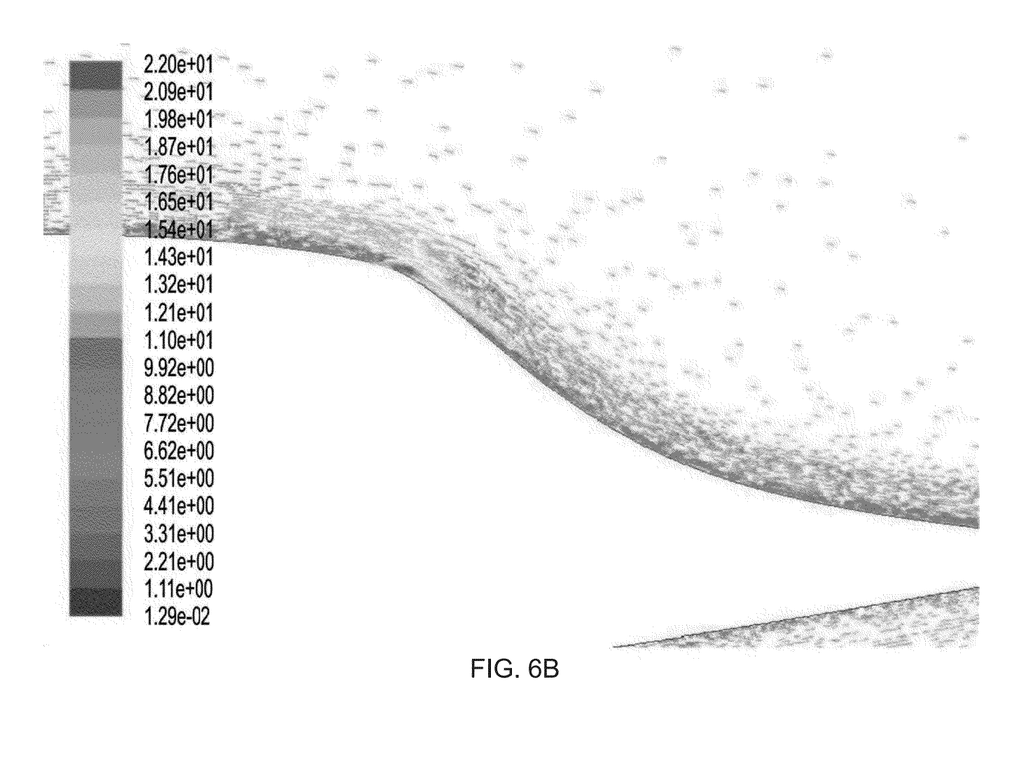

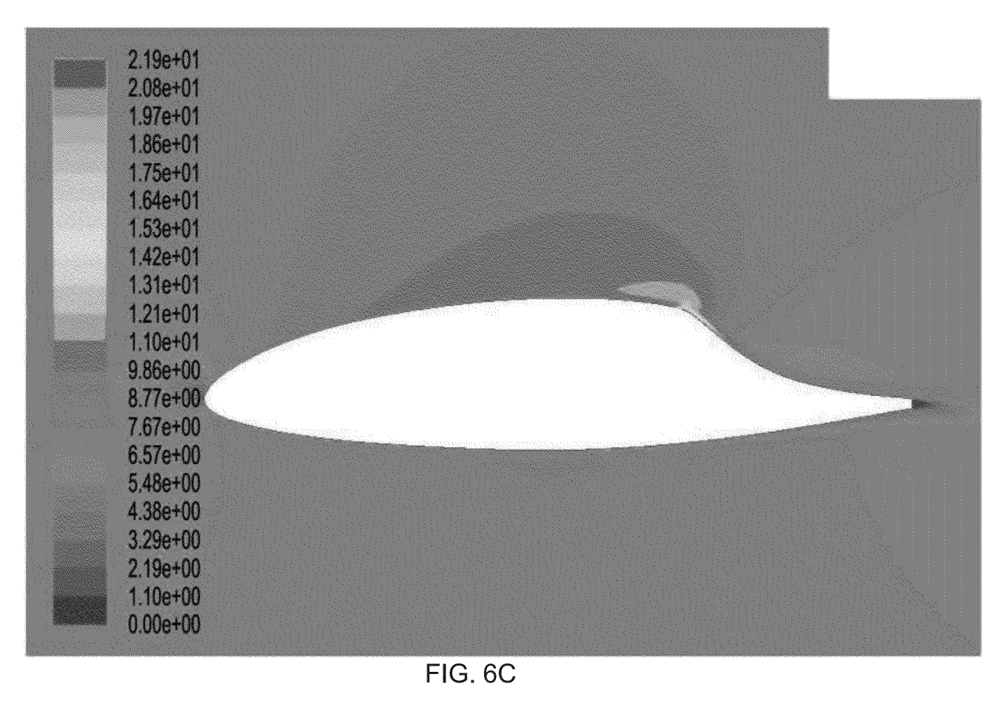

FIGS. 6A-C show simulation results for case (c), where FIG. 6A shows velocity vectors, FIG. 6B shows velocity vectors enlarged near the blowing slot, and FIG. 6C shows velocity iso-contours.

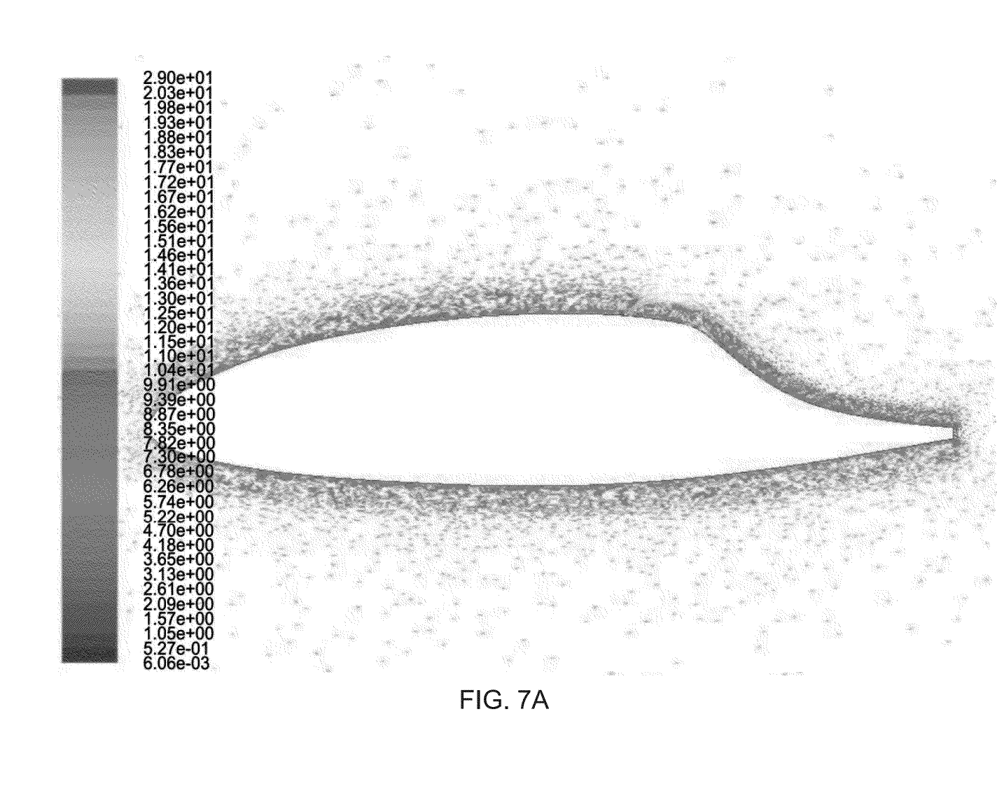

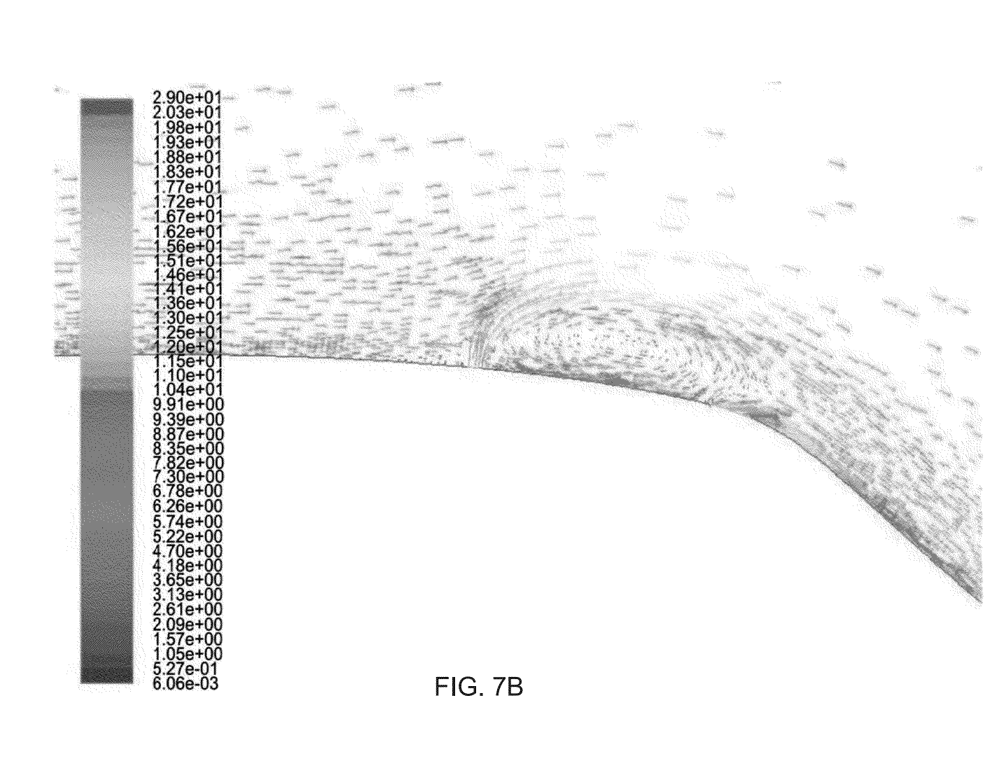

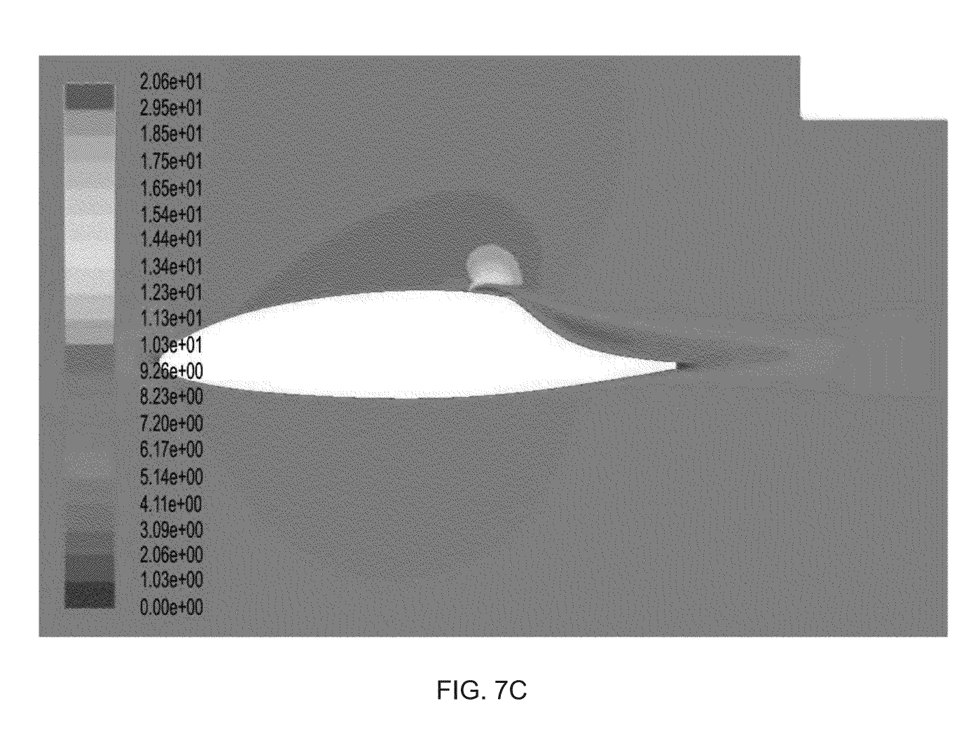

FIGS. 7A-C show simulation results for case (d), where FIG. 7A shows velocity vectors, FIG. 7B shows velocity vectors near the two blowing slots, and FIG. 7C shows velocity iso-contours.

The simulations presented in these examples demonstrated that the first upstream actuator separates the flow from the surface upstream and therefore produces more drag and less lift (Table 1). The simulation also demonstrated that the second actuator, when operated alone, reattaches the BL and creates more lift and less drag. The simulation also demonstrated that when the both the actuators are operative, intermediate values for the drag and lift are achievable. Thus, by changing the jet velocity coming from the oscillators, any intermediate lift value and drag value, at least within the range defined by the results of cases (a)-(c), can be obtained. The obtainable lift and/or drag values when two or more blowing actuators are operative can, in some embodiments of the present invention, exceed the lift and/or drag values that are obtainable when only one of the blowing actuators is operative. The inventors of the present invention demonstrated significant performance variations that are comparable to airfoil incidence angle variation of at least 5 degrees.

It is expected that during the life of a patent maturing from this application many relevant fluidic oscillatory actuators, and blowing actuators will be developed and the scope of the terms fluidic oscillatory actuators and blowing actuators is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A fluidic system, comprising a switching valve having a fluidic oscillatory actuator, a first blowing actuator being switchable by said switching valve and configured for producing an output of fluid flow engaging a first plane, and a second blowing actuator, also being switchable by said switching valve and configured for producing an output of fluid flow engaging a second plane, different from said first plane.

2. The system according to claim 1, wherein at least one said first blowing actuator and said second blowing actuator is a pulsed blowing actuator.

3. The system according to claim 1, wherein at least one said first blowing actuator and said second blowing actuator is a sideways oscillation pulsed blowing actuator.

4. The system according to claim 1, further comprising at least one additional blowing actuator, also being switchable by said switching valve and configured for producing an output of fluid flow engaging at least one additional plane, different from said first and said second planes.

5. The system according to claim 1, wherein said first and said second planes intersect.

6. The system according to claim 5, wherein said first and said second planes are perpendicular to each other.

7. The system according to claim 5, wherein said first and said second blowing actuators are arranged generally parallel to an intersection line between said first and said second planes.

8. The system according to claim 5, wherein said first and said second blowing actuators are arranged at an angle to an intersection line between said first and said second planes.

9. The system according to claim 5, wherein said first and said second blowing actuators are arranged generally perpendicular to an intersection line between said first and said second planes.

10. The system according to claim 1, being mounted on an aerodynamic or hydrodynamic, internal or external, wall surface, wherein said first blowing actuator is arranged to separate a boundary layer of fluid flow from said wall surface.

11. The system according to claim 10, wherein at least one of said blowing actuators is arranged to provide pulsed blowing oscillation of fluid flow, generally normal to said surface.

12. The system according to claim 10, wherein at least one of said blowing actuators is arranged to provide pulsed blowing oscillation of fluid flow, generally tangentially to said surface.

13. The system according to claim 1, being mounted on an aerodynamic or hydrodynamic, internal or external, wall surface of an object, wherein said first blowing actuator is arranged to separate a boundary layer of fluid flow from said wall surface, and said second blowing actuator is arranged to reattach said boundary layer to said wall surface.

14. The system according to claim 1, wherein said first blowing actuator is mounted on a first aerodynamic or hydrodynamic wall surface of an object and is arranged to provide pulsed blowing oscillation of fluid flow, generally tangentially to said first surface, and said second blowing actuator is mounted on a second aerodynamic or hydrodynamic wall surface of said object and is arranged to provide pulsed blowing oscillation of fluid flow, generally perpendicular to said second surface.

15. The system according to claim 14, wherein said first surface and second surfaces are on opposite sides of said object.

16. The system according to claim 14, wherein said first surface is an upper surface of said object, and said second surface is a lower surface of said object.

17. The system according to claim 14, wherein said second surface is an upper surface of said object, and said first surface is a lower surface of said object.

18. The system according to claim 10, wherein said object is selected from the group consisting of an aerial vehicle, a ground vehicle, an aqueous vehicle, a subaqueous vehicle, an amphibious vehicle, a semi-amphibious vehicle, an aircraft wing, a control or aero surface of a vehicle, and an internal passageway.

19-26. (canceled)

27. The system according to claim 1, further comprising a controller configured for activating said switching valve to provide a coefficient selected from the group consisting of a predetermined lift coefficient and a predetermined drag coefficient.

28. (canceled)

29. The system according to claim 1, further comprising a controller configured for activating said switching valve to simultaneously control a drag coefficient and a lift coefficient.

30. The system according to claim 1, further comprising a controller configured for activating said switching valve to provide a generally constant lift coefficient and a varying drag coefficient.

31. The system according to claim 1, further comprising a controller configured for activating said switching valve to provide a generally constant drag coefficient and a varying lift coefficient.

32. The system according to claim 1, further comprising a controller configured for activating said switching valve to provide alternating blowing between a lower and an upper surface of said object.

33. A method of controlling flow, comprising: operating a switching valve having a fluidic oscillatory actuator to switch a first blowing actuator to produce an output of fluid flow engaging a first plane, and a second blowing actuator to produce an output of fluid flow engaging a second plane, different from said first plane.

34. The method according to claim 33, further comprising operating said switching valve to switch at least one additional blowing actuator to producing an output of fluid flow engaging at least one additional plane, different from said first and said second planes.

35. The method according to claim 34, wherein said first blowing actuator is an SOaB actuator and the method comprises operating said SOaB actuator to form steady suction for wall attachment.

36. The method according to claim 35, wherein said steady suction is simultaneous with tangential blowing flow.
